(19) United States
(12) Patent Application Publication
(10) Pub. No.: US 2007/0035194 A1
(43) Pub. Date: Feb. 15, 2007

(54) Direct-current motor

(75) Inventor: Rudiger Briesewitz, Bruckkobel (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/573,219

(22) PCT Filed: Sep. 24, 2004
(86) PCT No.: PCT/EP04/52299

§ 371 Date: Mar. 24, 2006

(30) Foreign Application Priority Data
Sep. 25, 2003 (DE) 10344754.7
Sep. 2, 2004 (DE) 102004042937.5

(51) Int. Cl. F04B 1/06; H01R 39/06; H01R 39/38

(52) U.S. Cl. 310/237; 417/410.1; 417/221; 417/415; 310/239

(57) ABSTRACT

Disclosed is a direct-current motor equipped with a housing, a rotor, and a stator having electrical windings. A commutator/carbon-brush system is provided in order to energize the electrical windings, with the stator embracing the rotor which includes a shaft and permanent magnets. To improve the drive of a pump used in a vehicle brake system, the commutator is arranged in a rotationally fixed manner and carbon brushes are provided which can rotate with the rotor and are displaceable towards the commutator in the direction of wear.

### BACKGROUND OF THE INVENTION

The present invention relates to a direct-current motor equipped with a housing, a rotor, and a stator which comprises electrical windings, and a commutator/carbon-brush system is provided in order to energize the electrical windings in dependence on the rotary position of the rotor, and with the stator embracing the rotor which comprises a shaft and permanent magnets.

A high copper factor is enabled because the windings are mounted at the stator which embraces the rotor radially outwards. This has positive effects on the performance of the direct-current motor. For an application in the range of mechatronics, in particular in the field of automotive engineering, there is the general requirement of having a powerful and yet small-size electric motor. While the miniaturization of microelectronic components is advanced, electromechanical modules require further miniaturization. An additional demand placed on direct-current motors for driving vehicle aggregates is to achieve a smooth, fail-free operation. In particular when direct-current commutator motors are used for driving fluid pumps, this necessitates an increased effort in avoiding or storing/discharging leakage fluids, and for sealing. The reason is that the function of the commutator can be considerably impaired e.g. by the ingress of a mixture of brake fluid and coal dust.

### SUMMARY OF THE INVENTION

To solve the problems mentioned above, it is suggested for a generic direct-current motor that the commutator is arranged in a rotationally fixed manner, and that carbon brushes are provided which can rotate with the rotor and are displaceable towards the commutator in the direction of wear. In contrast to prior-art motors, the direct-current motor of the invention comprises a stationary commutator, and the carbon brushes perform a rotation along with the rotor. Because the carbon brushes are associated with the rotor, rather than with the stator as has previously been the case, it is possible to split up the mounting space in a way appropriate to achieve an improved integration of the direct-current motor at an accommodating member for a pump driven by the direct-current motor.

It is advisable to arrange the carbon brushes in such a manner that the centrifugal forces which act will not reduce the brush application forces. Also, a support of the brush contact forces is not generally desired because this increases losses induced by friction. A tuning which is at least largely neutral with respect to forces is considered optimal.

According to a favorable embodiment of the invention, the rotor is shaped like a bowl as a supporting body including a bowl wall for the mounting support of the permanent magnets. The permanent magnets are mounted at the radially outward bowl wall in a rotationally fixed manner. The bowl houses in its interior the carbon brushes which are arranged in a rotationally fixed manner relative to the rotor, yet are adapted to be fed linearly in the direction of the commutator.

In another favorable embodiment, the carbon brushes are provided in a brush holder which is integrated in the bowl's interior. This provision renders a simplified installation of the brush assembly in the supporting body possible.

For a defined rotary entrainment of the brush holder, the latter can be provided with a catch engaging positively a recess of the supporting body, or vice versa. The catch can be designed e.g. as a step, projection, serration, or in a similar fashion, positively engaging a recess, groove, or a similar form at a counterpart, or it makes catch at the counterpart in operative manner. For this purpose, the brush holder is preferably made of a plastic material.

The overall length of the direct-current motor is advantageously reduced because the commutator is designed flatly at a housing component of the electric motor and extends at right angles to the shaft, with the carbon brushes being displaceable in parallel to the shaft in the direction of the commutator. This type of construction also minimizes the influence of the centrifugal forces on the brush contact forces.

A particularly good protection of the commutator/carbon-brush system against the ingress of leakage fluid of a driven pump is rendered possible when the commutator is provided at a cover or at a bottom of a motor bowl which is positioned on the side of the shaft opposed to the power take-off. In principle, even an arrangement of the commutator/carbon-brush system close to the power take-off is possible, following another embodiment, because the axial commutator allows catapulting contaminants. The commutator/carbon-brush system comprises at least two oppositely charged carbon brushes, and an electrical connection is established between the oppositely charged carbon brushes. It is especially favorable that this electrical connection is integrated in the brush holder. In an additional favorable embodiment of the invention, the oppositely charged carbon brushes are arranged diametrically opposite each other.

A particularly space-saving arrangement is achieved when the center of the brush holder is hollow and when the housing component which carries the commutator additionally carries an anti-interference unit which protrudes at least in part into the hollow center of the brush holder.

In another construction of an electric motor with small overall dimensions, the oppositely charged carbon brushes are arranged diametrically opposite each other, with one of the carbon brushes being provided in the center of the brush holder, while the other one of the carbon brushes is positioned radially outside the center, and the brush holder includes an integrated anti-interference unit which is disposed diametrically opposite in relation to the carbon brush that is arranged radially outwards.

A carbon brush design with a precise brush guiding and reduced wear is achieved when the brushes have a round or multi-cornered, in particular square-shaped cross-section, with the brush holder including profiled guides for the form-fit accommodation of the carbon brushes.

In order to procure the direct-current motor from a supplier as a unit which can be handled independently and tested independently, it is arranged for that the cover or motor bowl carries a bearing for the mounting support of the shaft in such a manner that test service of the motor is allowed, and that in the regular operation of the motor, bearing forces can be introduced through this bearing directly into an accommodating member for the accommodation of a driven element. For this purpose, the bearing, with the motor mounted, is slipped into a stepped bore of the accommodating member.

Manufacture of the rotor is simplified when the shaft is connected to the supporting body for the permanent magnets in a rotationally fixed manner, with the shaft being designed with the supporting body particularly in positive or operative engagement, in a molecular bond, or by being integral therewith.

It is advisable for an improved electrical contacting of the direct-current motor that due to an axially directed assembly of commutator and electrical windings, an automatic electrical contacting between these components is provided. Resiliently preloaded spring legs are provided between commutator and windings to this end. The spring legs can be provided either at the windings, or at the commutator lamellas, or at a separate component interposed between windings and commutator.

The invention further relates to an electrohydraulic assembly equipped with the direct-current motor described hereinabove.

### BRIEF DESCRIPTION OF THE DRAWINGS

Further details of the invention can be taken from the subsequent description making reference to the accompanying drawings. In the drawings:

FIG. 1 is a longitudinal cross-sectional view of an assembly with a flanged direct-current motor of small overall dimensions;

FIG. 2 is a longitudinal cross-sectional and enlarged view of a modified embodiment;

FIG. 3 is a view in the direction of the arrow III in FIG. 3; and

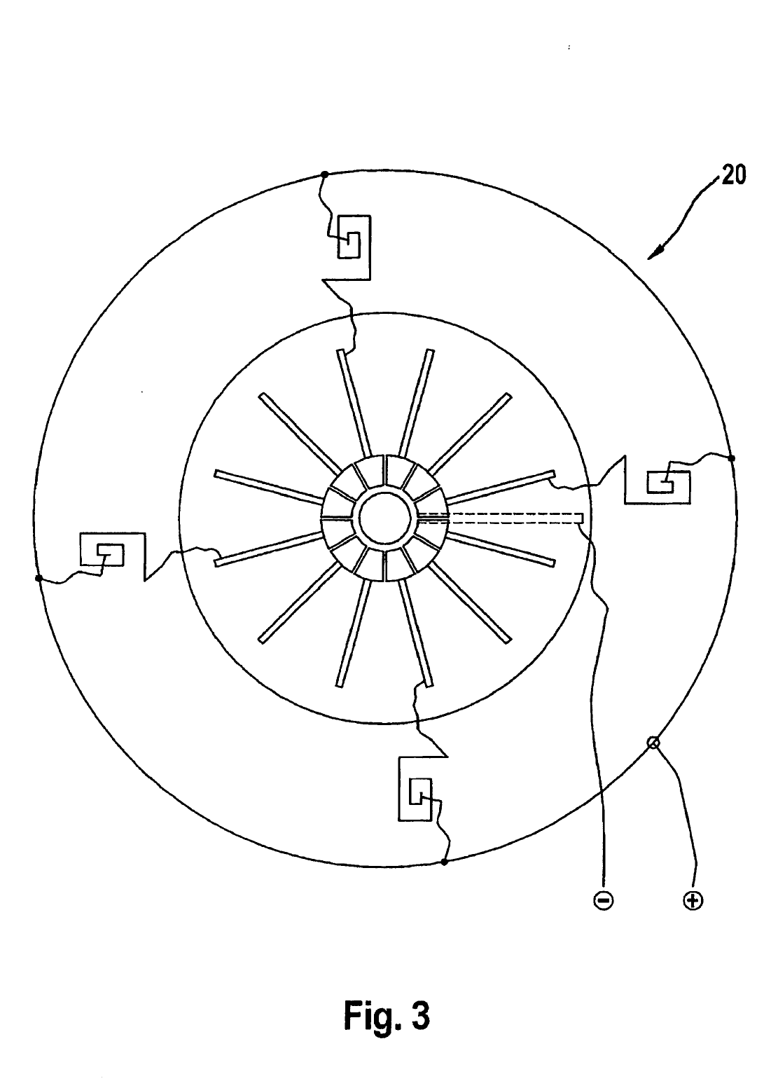

FIG. 4 is an additionally modified embodiment of the invention.

### DETAILED DESCRIPTION OF THE DRAWINGS

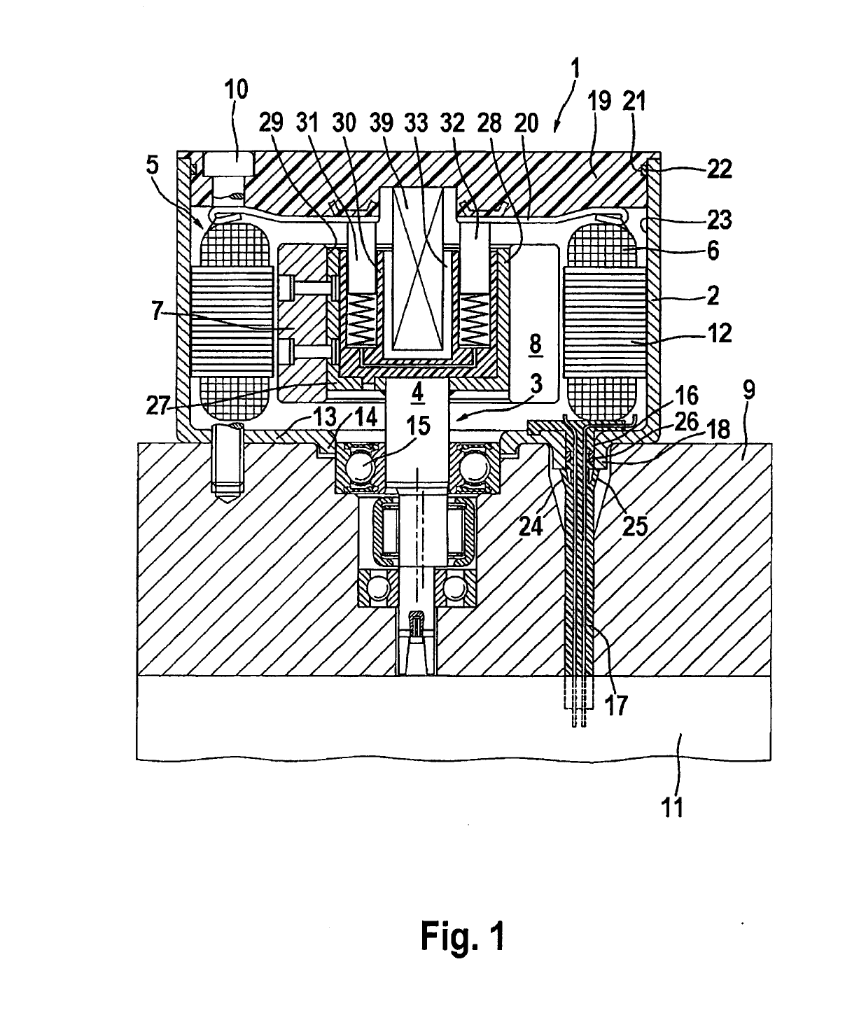

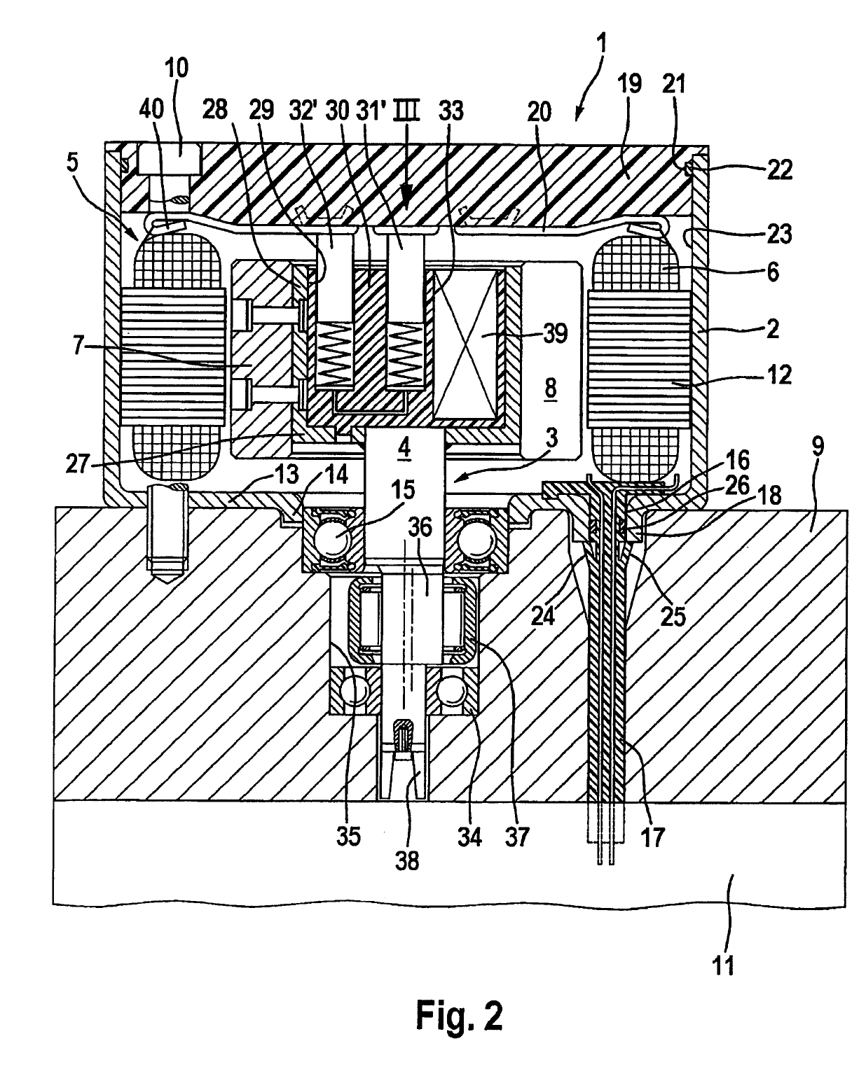

According to FIGS. 1 and 2, a direct-current motor 1 comprises a motor housing 2, a rotor 3 with a shaft 4 and a stator 5 having electrical windings 6, with a commutator/carbon-brush system being provided in order to energize the electrical windings 6, and with the stator 5 embracing the rotor 3 which includes the shaft 4 and permanent magnets 7, 8. The direct-current motor 1 is flanged to an accommodating member (HCU) 9 for accommodating a hydraulic pump. The direct-current motor 1 is used to drive the hydraulic pump. A fastening screw 10 extending through the direct-current motor 1 is used to fasten the components at each other. The fastening screw 10 can reach through the accommodating member 9 and additionally serves for fastening an electronic control unit (ECU) 11. The latter unit is arranged on a side of the accommodating member 9 opposite the direct-current motor 1 and is used for the current supply to the direct-current motor 1 in addition to the actuation of electrohydraulic valves.

The stator 5 comprises the bowl-shaped motor housing 2 of thin sheet which is open on one side and in which a winding carrier (sheet-metal package) 12 with the electrical windings 6 is fastened, and which embraces the rotor 3 at least over parts of its length. For the mounting support of the rotor, a bowl bottom 13 of the motor housing 2 comprises a collar 14 for the accommodation of a bearing 15 and, further, a passage for the driven end of shaft 4. In addition, a recess 16 is provided in the bowl bottom 13 and used in particular as a passage for a plug-type supply element 17. The recess 16 can include a collar 18 being shaped in the direction of the accommodating member 9, similar to the collar 14 for the bearing 15. An open end of the motor housing 2 is arranged on a side opposite the power take-off. The open housing end can be closed by means of a cover 19 which carries a stationary, flat commutator 20 (axial commutator) whose main direction of extension is at right angles to the shaft 4. There is no rotor bearing on this side of the direct-current motor 1. The commutator 20 is a central part of the cover 19. Cover 19 is preferably made of an insulating plastic material and has a groove 21 on the periphery to accommodate a sealing element 22 which bears radially against an inside wall 23 of the motor housing 2. The windings 6 are connected to a current supply in the electronic control unit 11 by way of the plug-type supply element 17. The contacting between winding 6 and plug 18 takes place at two tongues. The plug 17 is provided with locking hooks 24, 25 to provide locking by way of the locking hooks resiliently abutting on the collar 18 of the motor housing 2. A radial seal 26 seals the plug 17, as shown in FIG. 2, relative to the collar 18 or alternatively relative to the accommodating member 9. The current circuit for the temporary energization of the windings 6 is closed by way of the commutator/coal-brush system arranged downstream of the windings.

The rotor 3 has a supporting body 27 which has the shape of a bowl or a revolver and is open on one side. The rotor drum can be a deepdrawn/pressed piece to which the hardened and ground shaft 4 is welded. The permanent magnets 7, 8 are arranged radially outwards on the bowl wall 28 in a rotationally fixed manner and resistant to centrifugal forces. The attachment of the permanent magnets 7, 8 at the supporting body 27 is preferably performed by way of cementing or riveting. For example, two, four or six magnet poles are employed. In the bowl interior of the supporting body 27, there is a recess 29 which accommodates a brush holder 30 having the form of a simple plastic housing. The plastic housing 30 is fixed in form lock at the supporting body 27 preferably by means of one or several catches and comprises two carbon brushes 31, 32 which are resiliently loaded in the direction of the commutator and are in electric contact with each other. The carbon brushes 31, 32 extend in parallel to the shaft 4. The plastic housing is recessed in the center according to FIGS. 1 and 2. The anti-interference unit 39 being electrically connected at least to the +brush is disposed in the opening 33. The carbon brushes 31, 32 are arranged diametrically relative to each other in order to minimize unbalance effects.

In the embodiment of FIG. 2, one of the carbon brushes 31′ is centrically arranged, while the other carbon brush 32′ is placed radially offset thereto. The recess for the anti-interference unit 39, which preferably comprises a capacitor and/or coils, is arranged diametrically relative to the radially outward carbon brush 32′.

The mounting support of the rotor 3 is placed completely in the accommodating member 9 in all embodiments and, namely, by means of the above-mentioned bearing 15 (rolling bearing) and by means of another rolling bearing 34 which is inserted into a stepped bore 35 of the accommodating member 9 and supports the shaft end. As a result, an eccentric 36 having an eccentric bearing 37 is compressed in a defined manner between the two bearings 34, 15. A driving element (small propeller) can be mounted at the shaft end to deliver pump leakage fluid into a space provided for this purpose (leakage receiving chamber, ambient atmosphere, or the like). To this end, a propeller 38 can be arranged at the frontal end of shaft 4, being attached to shaft 4 in a form-lock by using a notched nail.

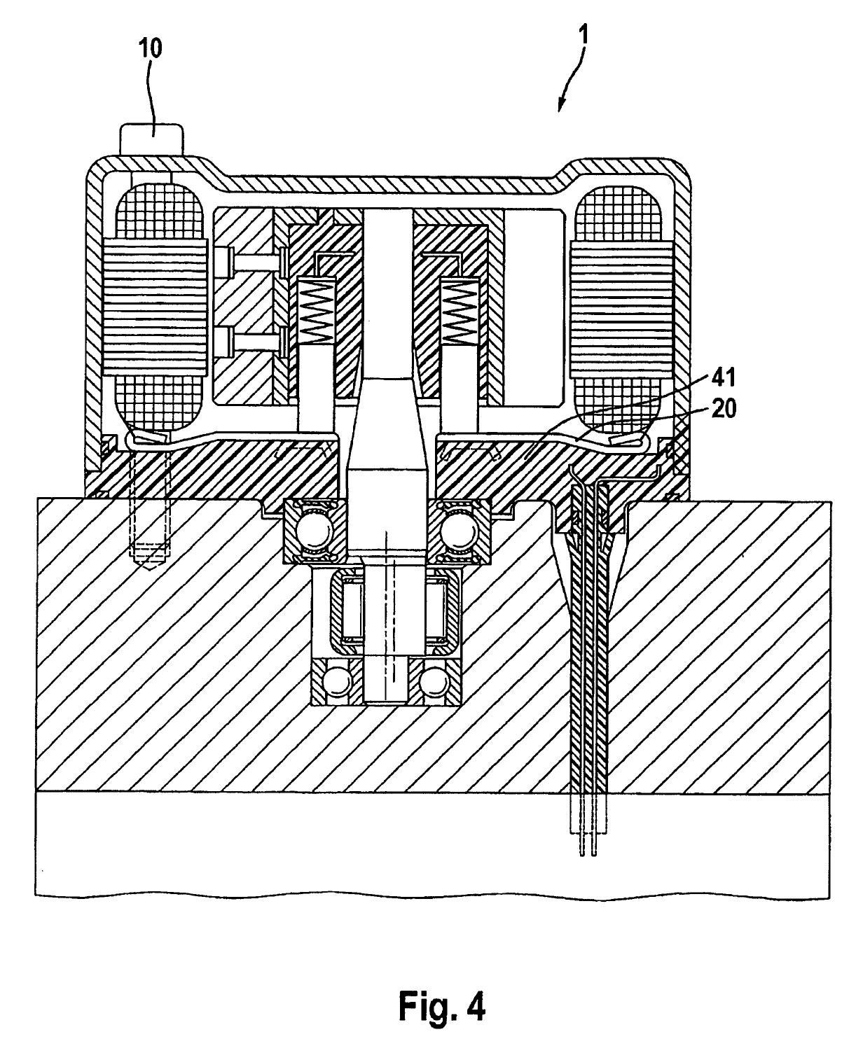

The embodiment of FIG. 4 differs from FIGS. 1 and 2 only in that the bowl bottom 13 of the motor housing 2 is configured as an end plate 41 with an integrated commutator 20, while the integrally shaped bowl bottom is arranged on a side opposite to the output end of the shaft, and in that the stepped bore 35 is designed like a blind hole.

Summarizing, the invention is based on the following fundamental ideas:
the carbon brushes are arranged inwards and in axial direction
the permanent magnets are attached to the rotor
the winding end forms the stator
the rotor has a drum shape
the screw coupling for attachment is performed by the motor
the brush holder optionally receives anti-interference elements (the main direction of extension is axial).

It is a major advantage of the invention that an automatic electrical contacting between components is rendered possible because commutator 20 and windings 6 are not arranged offset radially relative to each other but are arranged offset axially relative to each other and are joined in an axially directed fashion. First, the brush holder 30 is mounted into the bowl-shaped supporting body 27 and, after completion, the supporting body 27 is welded to the shaft 4.

Another major advantage of the invention involves that the rotor mounting support is placed at the output end of shaft 4, while the opposite end of the shaft 4 overhangs freely and retains an inwards hollow supporting body 27 for permanent magnets 7, 8, with the hollow portions of the supporting body 27 being used for the arrangement of axially directed carbon brushes 31, 32. In order to nonetheless allow procurement of the complete ready-to-mount direct-current motor 1 from a supplier, it is sufficient for a load-free test service at the supplier's premises when the rotor 3 is retained in the motor housing 2 exclusively by way of the bearing 15.

The invention is not limited to a direct-current motor, isolated in the sense of a partial protection, but further covers a complete electrohydraulic aggregate for a slip-controlled brake system with driving stability control, comprising the accommodating member 9 for hydraulic components, comprising an electronic control unit 11 with electronic components as well as preferably a power stage for the above-described direct-current motor which is provided for driving a fluid pump (brake fluid pump).

List of Reference Numerals:

1. direct-current motor
2. motor housing
3. rotor
4. shaft
5. stator
6. windings
7. permanent magnet
8. permanent magnet
9. accommodating member
10. fastening screw
11. electronic control unit
12. winding carrier
13. bowl bottom
14. collar
15. earing
16. recess
17. supply element (plug)
18. collar
19. cover
20. commutator
21. groove
22. sealing element
23. inside wall
24. locking hook
25. locking hook
26. radial seal
27. supporting body
28. bowl wall
29. recess
30. brush holder
31. carbon brush
32. carbon brush
33. opening
34. bearing
35. stepped bore
36. eccentric
37. eccentric bearing
38. propeller
39. anti-interference unit
40. spring leg
41. end plate

1-18. (canceled)

19. A direct-current motor (1) comprising:
a motor housing (2);
a rotor (3);
a stator (5) having electrical windings (6); and
a commutator/carbon-brush system provided in order to energize the electrical windings (6) in dependence on the rotary position of the rotor (3), and with the stator (5) embracing the rotor (3) which comprises a shaft (4) and permanent magnets (7, 8), wherein the commutator (20) is arranged in a rotationally fixed manner, and carbon brushes (31, 32) are provided which can rotate with the rotor (3) and are displaceable towards the commutator (20) in the direction of wear.

20. A direct-current motor according to claim 19, wherein the rotor (3) includes a bowl-shaped supporting body (27) for the permanent magnets (7, 8), at the radially outward bowl wall (28) whereof the permanent magnets (7, 8) are provided in a rotationally fixed manner, and the carbon brushes (31, 32) are arranged in an interior of the bowl in a rotationally fixed manner.

21. A direct-current motor according to claim 20, wherein the shaft (4) is connected to the supporting body (27) for the permanent magnets (7, 8) in a rotationally fixed manner, with the shaft (4) being designed with the supporting body (27) in a positive or operative engagement, in a molecular bond, or by being integral therewith.

22. A direct-current motor according to claim 20, wherein the carbon brushes (31, 32) are provided in a brush holder (30) which is arranged in the interior of the bowl.

23. A direct-current motor according to claim 22, wherein the brush holder (30) includes at least one catch engaging positively the supporting body (27), or the supporting body (27) includes at least one catch engaging positively the brush holder (30).

24. A direct-current motor according to claim 22, wherein the brush holder (30) is made of a plastic material.

25. A direct-current motor according to claim 22, wherein the brush holder (30) comprises at least two oppositely charged carbon brushes (31, 32), and an electrical connection is established between the oppositely charged carbon brushes.

26. A direct-current motor according to claim 25, wherein the electrical connection established between the two carbon brushes (31, 32) is integrated in the brush holder (30).

27. A direct-current motor according to claim 25, wherein the oppositely charged carbon brushes (31, 32) are arranged diametrically opposite each other.

28. A direct-current motor according to claim 25, wherein the oppositely charged carbon brushes (31, 32) are arranged diametrically opposite each other, with one of the carbon brushes (31) being provided in the center of the brush holder (30) and another one of the carbon brushes (32) being positioned radially outside the center, and the brush holder (30) includes an integrated anti-interference unit (39) which is disposed diametrically opposite in relation to the carbon brush (32) arranged radially outwards.

29. A direct-current motor according to claim 22, wherein the center of the brush holder (30) is hollow, and the brush holder (30) includes a housing component carrying an anti-interference unit (39) which protrudes at least in part into the hollow center of the brush holder (30).

30. A direct-current motor according to claim 19, wherein the commutator (20) is designed flatly at a housing element of the electric motor and extends at right angles to the shaft (4), with the carbon brushes (31, 32) being displaceable in parallel to the shaft (4) in the direction of the commutator (20).

31. A direct-current motor according to claim 30, wherein the commutator (20) is provided at a cover (19) or at a bottom of the motor housing (2).

32. A direct-current motor according to claim 31, wherein the cover (19) or bottom carries a bearing (15) for the mounting support of the shaft (4) in such a manner that a test service of the direct-current motor (1) is allowed, and in the regular operation of the direct-current motor (1), bearing forces are introduced through the bearing (15) into an accommodating member (9) for the accommodation of a driven element.

33. A direct-current motor according to claim 19, wherein the carbon brushes (31, 32) have a round, multi-cornered, or square-shaped cross-section, and the brush holder (30) includes profiled guides for form-fit accommodation of the carbon brushes (31, 32).

34. A direct-current motor according to claim 19, wherein due to an axially directed assembly of commutator (20) and electrical windings (6), an automatic electrical contacting between these components is provided.

35. A direct-current motor according to claim 34, further comprising: resiliently preloaded spring legs (40) provided between the commutator (20) and the windings (6) for the electrical contacting, and the spring legs (40) are provided either at the windings (6), or at commutator lamellas, or at a separate component interposed between windings (6) and commutator (20).

36. An electrohydraulic assembly for a slip-controlled brake system with driving stability control, comprising:
hydraulic components including an electronic control unit (11);
a motor including a housing (2), a rotor (3), a stator (5) having electrical windings (6), and a commutator/carbon-brush system provided in order to energize the electrical windings (6) in dependence on the rotary position of the rotor (3), and with the stator (5) embracing the rotor (3) which comprises a shaft (4) and permanent magnets (7, 8), wherein the commutator (20) is arranged in a rotationally fixed manner, and carbon brushes (31, 32) are provided which can rotate with the rotor (3) and are displaceable towards the commutator (20) in the direction of wear; and
an accommodating member (9) for the hydraulic components and for a power stage for the motor.
